(19) United States
(12) Patent Application Publication
(10) Pub. No.: US 2026/0066470 A1
(43) Pub. Date: Mar. 5, 2026

(54) SECONDARY BATTERY AND METHOD FOR MANUFACTURING THE SAME

(71) Applicant: SAMSUNG SDI CO., LTD., Yongin-si, Gyeonggi-do (KR)

(72) Inventor: Byung-Woo PARK, Yongin-si (KR)

(21) Appl. No.: 19/175,124

(22) Filed: Apr. 10, 2025

(30) Foreign Application Priority Data
Sep. 3, 2024 (KR) 10-2024-0119186

(51) Int. Cl. H01M 50/466; H01M 10/04; H01M 50/403; H01M 50/46; H01M 50/586; H01M 50/595

(52) U.S. Cl. CPC H01M 50/466; H01M 10/0459; H01M 50/403; H01M 50/46; H01M 50/586; H01M 50/595

(57) ABSTRACT

A secondary battery, including a first electrode including a first substrate and a first active material layer on the first substrate, a second electrode including a second substrate and a second active material layer on the second substrate, and a separator between the first active material layer and the second active material layer, wherein the separator includes a double layer at a first end of the separator.

### CROSS-REFERENCE TO RELATED APPLICATION

The present application claims priority to and the benefit of Korean Application No. 10-2024-0119186, filed on Sep. 3, 2024, in the Korean Intellectual Property Office, the entire disclosure of which is incorporated by reference herein.

### BACKGROUND

### 1. Field

Embodiments of the present disclosure relate to a secondary battery and a method of manufacturing the secondary battery.

### 2. Description of the Related Art

Unlike primary batteries that are not designed to be (re) charged, secondary (or rechargeable) batteries are batteries that are designed to be discharged and recharged. Low-capacity secondary batteries are used in portable, small electronic devices, such as smart phones, feature phones, notebook computers, digital cameras, and camcorders, while large-capacity secondary batteries are widely used as power sources for driving motors in hybrid vehicles and electric vehicles and for storing power (e.g., home and/or utility scale power storage). A secondary battery generally includes an electrode assembly composed of a positive electrode and a negative electrode, a case accommodating the same, and electrode terminals connected to the electrode assembly.

The above information disclosed in this Background section is for enhancement of understanding of the background of the present disclosure, and therefore, it may contain information that does not constitute related (or prior) art.

### SUMMARY

Embodiments include a secondary battery, including a first electrode including a first substrate and a first active material layer on the first substrate, a second electrode including a second substrate and a second active material layer on the second substrate, and a separator between the first active material layer and the second active material layer, wherein the separator includes a double layer at a first end of the separator.

The double layer may be a folded portion of the separator.

The first end of the separator may protrude beyond the first active material layer and the second active material layer in a longitudinal direction of the separator.

The second active material layer may extend beyond the first active material layer in a direction toward the first end of the separator, and the double layer may be a portion of the separator folded toward the first active material layer.

The first active material layer may include a positive electrode active material, and the first electrode may be a positive electrode.

The double layer may include a folded portion of the separator, an opposing portion facing the folded portion, and an adhesive layer between the folded portion and the opposing portion.

The adhesive layer may include a binder.

The double layer may be compressed, resulting in a compressed double layer, and a thickness of the compressed double layer may be equal to or less than twice a thickness of a region of the separator excluding the double layer.

The first electrode may include a first electrode tab connected to the first substrate, the second electrode may include a second electrode tab connected to the second substrate, and each of the first electrode tab and the second electrode tab may extend beyond the first end of the separator in a longitudinal direction of the separator.

The double layer may include a contact portion of the separator, and an insulating tape attached to the contact portion.

The insulating tape may include a same material as the separator.

The insulating tape may include at least one of polyimides and polyethylene terephthalate.

A thickness of the insulating tape may be greater than a thickness of the separator.

A portion of the second active material layer may extend beyond the first active material layer in a longitudinal direction of the separator, the separator may have a first surface and a second surface opposite to the first surface, the first surface of the separator may face the first active material layer, the second surface of the separator may face the second active material layer, and the insulating tape may be on the first surface.

Embodiments include an electrode assembly for a secondary battery, the electrode assembly including a first electrode including a first substrate and a first active material layer on the first substrate, a second electrode including a second substrate and a second active material layer on the second substrate, and a separator between the first active material layer and the second active material layer, wherein the separator includes a double layer at a first end of the separator.

The double layer may be a folded portion of the separator.

The double layer may include a contact portion of the separator, and an insulating tape attached to the contact portion.

Embodiments include a method for manufacturing a secondary battery, the method including preparing a first electrode including a first substrate and forming a first active material layer on the first substrate, preparing a second electrode including a second substrate and forming a second active material layer on the second substrate, and disposing a separator between the first active material layer and the second active material layer, wherein the separator includes a double layer formed at a first end of the separator.

The method may further include forming the double layer by folding a portion of the separator.

The method may further include forming the double layer including a contact portion of the separator, and attaching an insulating tape to the contact portion.

These and other aspects and features of the present disclosure will be described in or will be apparent from the following description of embodiments of the present disclosure.

However, aspects and features of the present disclosure are not limited to those described above, and other aspects and features not mentioned will be clearly understood by a person skilled in the art from the detailed description, described below.

### BRIEF DESCRIPTION OF DRAWINGS

The following drawings attached to this specification illustrate embodiments of the present disclosure, and further describe aspects and features of the present disclosure together with the detailed description of the present disclosure. Thus, the present disclosure should not be construed as being limited to the drawings.

Features will become apparent to those of ordinary skill in the art by describing in detail exemplary embodiments with reference to the attached drawings, in which:

FIG. 1 illustrates a schematic view of a secondary battery according to one or more embodiments of the present disclosure;

FIG. 2 illustrates an example of a first electrode, a second electrode, and a separator according to one or more embodiments of the present disclosure;

FIG. 3 illustrates a side view of an electrode assembly according to one or more embodiments of the present disclosure;

FIG. 4 illustrates a process of folding a separator according to one or more embodiments of the present disclosure;

FIG. 5 illustrates a side view of an electrode assembly according to another embodiment of the present disclosure;

FIG. 6 illustrates a process of attaching an insulating tape to a separator according to one or more embodiments of the present disclosure;

FIG. 7 illustrates a side view of a thermally shrunk electrode assembly according to a comparative example of the present disclosure;

FIG. 8 illustrates a side view of a thermally shrunk electrode assembly according to one or more embodiments of the present disclosure; and

FIG. 9 illustrates a flowchart of an example of a method for manufacturing a secondary battery according to one or more embodiments of the present disclosure.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those of ordinary skill in the art.

In the drawing figures, the dimensions of layers and regions may be exaggerated for clarity of illustration. It will also be understood that when a layer or element is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. Like reference numerals refer to like elements throughout.

Hereinafter, embodiments of the present disclosure will be described, in detail, with reference to the accompanying drawings. The terms or words used in this specification and claims should not be construed as being limited to the usual or dictionary meaning and should be interpreted as meaning and concept consistent with the technical idea of the present disclosure based on the principle that the inventor can be his/her own lexicographer to appropriately define the concept of the term to explain his/her embodiments in the best way.

The embodiments described in this specification and the configurations shown in the drawings are only some of the embodiments of the present disclosure and do not represent all of the technical ideas, aspects, and features of the present disclosure. Accordingly, it should be understood that there may be various equivalents and modifications that can replace or modify the embodiments described herein at the time of filing this application.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112 (a) and 35 U.S.C. § 132(a).

References to two compared elements, features, etc. as being “the same” may mean that they are “substantially the same”. Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

Arranging an arbitrary element “above (or below)” or “on (under)” another element may mean that the arbitrary element may be disposed in contact with the upper (or lower) surface of the element, and another element may also be interposed between the element and the arbitrary element disposed on (or under) the element.

In addition, it will be understood that when a component is referred to as being “linked,” “coupled,” or “connected” to another component, the elements may be directly “coupled,” “linked” or “connected” to each other, or another component may be “interposed” between the components”.

Throughout the specification, when “A and/or B” is stated, it means A, B or A and B, unless otherwise stated. That is, “and/or” includes any or all combinations of a plurality of items enumerated. When “C to D” is stated, it means C or more and D or less, unless otherwise specified.

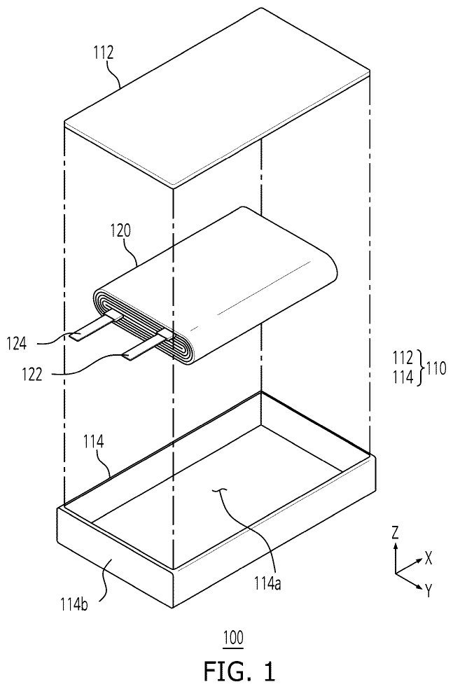

FIG. 1 illustrates a schematic view of a secondary battery 100 according to one or more embodiments of the present disclosure. Referring to FIG. 1, the secondary battery 100 may include a case 110 and an electrode assembly 120.

In the illustrated example of FIG. 1, the secondary battery 100 may be a prismatic secondary battery or a pouch-type secondary battery. However, the shape of the secondary battery 100 may be a cylindrical secondary battery, a button-type secondary battery, or the like.

The electrode assembly 120 may include a first electrode, a second electrode, and a separator. The separator may be provided between the first electrode and the second electrode. The electrode assembly 120 may be configured by winding or stacking the first electrode, the second electrode, and the separator therebetween. In the illustrated example of FIG. 1, the electrode assembly 120 is a winding type electrode assembly, but the shape and type of the electrode assembly 120 may, in other embodiments, be a stack type electrode assembly or another type.

The first electrode may be configured such that a first active material layer is formed on at least a portion of a first substrate. A first electrode tab 122 may extend outwardly from a first uncoated portion of the first substrate where the first active material layer is not applied, and the first electrode tab 122 may be electrically connected to the case 110 (e.g., a first terminal included in the case 110).

The second electrode may be configured such that a second active material layer is formed on at least a portion of a second substrate. A second electrode tab 124 may extend outwardly from a second uncoated portion of the second substrate where the second active material layer is not applied, and the second electrode tab 124 may be electrically connected to the case 110 (e.g., a second terminal included in the case 110). In the illustrated example of FIG. 1, the first electrode tab 122 and the second electrode tab 124 may extend in the same direction from the first electrode and the second electrode, respectively, such that the first electrode tab 122 and the second electrode tab 124 are formed on a first side of the electrode assembly 120. However, the first electrode tab 122 of the first electrode may be formed on a first side of the electrode assembly 120, and the second electrode tab 124 of the second electrode may be formed on a second side of the electrode assembly 120, which is the opposite side of the first side.

The first electrode tab 122 and the second electrode tab 124 formed on a first side of the electrode assembly 120 may be directly connected to the case 110. However, the structure in which the first and second electrode tabs 122 and 124 of the electrode assembly 120 are connected to the case 110 may vary. For example, each of the first electrode tab 122 and the second electrode tab 124 may form lead tabs to be connected to the case 110, or may be connected to the case 110 by using a strip terminal.

The first electrode may serve as a positive electrode. In this case, the first substrate may be formed of, for example, an aluminum foil, and the first active material layer may include, for example, a transition metal oxide. The second electrode may serve as a negative electrode. In this case, the second substrate may be formed of, for example, a copper foil or a nickel foil, and the second active material layer may include, for example, graphite.

The separator may serve to prevent a short circuit between the first electrode and the second electrode while allowing movement of lithium ions. The separator may be formed of, for example, a polyethylene film, a polypropylene film, a polyethylene-polypropylene film, or the like, but the material may vary.

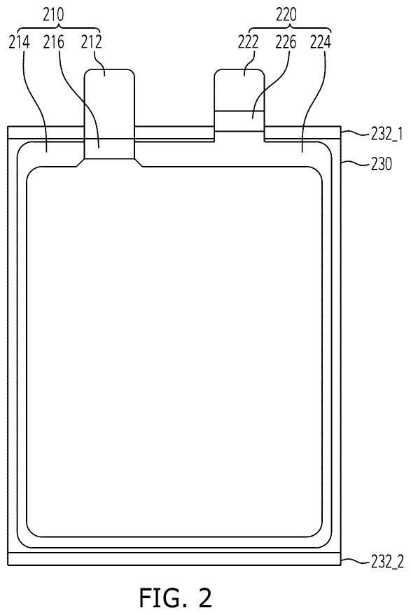

The separator may be interposed between the first electrode and the second electrode. Specifically, the separator may be disposed between the first active material layer of the first electrode and the second active material layer of the second electrode. Here, the separator may include a double layer positioned at one end or both ends (opposite ends). In particular, the double layer may be formed by folding a portion of the separator. In other embodiments, the double layer may be formed by attaching an insulating tape onto the separator. The structure and method of forming the double layer will be described in detail with reference to FIGS. 2 to 9.

The case 110 may accommodate the electrode assembly 120 and an electrolyte, and form an overall outer appearance of the secondary battery. Here, in a case where the electrode assembly 120 is a wound laminated structure, a winding axis may be parallel to a longitudinal direction (the X-axis direction) of the case 110. For example, the case 110 may include a receiving portion 114 configured to receive the electrode assembly 120 and a cover plate 112 configured to enclose the receiving portion 114. However, the case 110 may be formed in various shapes, such as a circular shape, a coin shape, and the like. The case may also be formed of a metal, such as stainless steel (SUS), aluminum, an aluminum alloy, a nickel-plated steel, a laminated film or plastic of which a pouch is formed of, or the like.

Referring to FIG. 1, the electrode assembly 120 may be inserted through an opening 114a formed at a first side of the receiving portion 114 of the case 110, and the opening 114a of the receiving portion 114 may be sealed by the cover plate 112. Thereafter, the joining portions of the receiving portion 114 and the cover plate 112 may be joined by welding.

In one or more embodiments, a first terminal may be formed on a first side surface 114b of the receiving portion 114. In addition, a second terminal may be further formed on the first side surface 114b of the receiving portion 114. The first electrode tab 122 of the electrode assembly 120 inserted into the receiving portion 114 may be electrically connected to the first terminal. Similarly, the second electrode tab 124 of the electrode assembly 120 inserted into the receiving portion 114 may be electrically connected to the second terminal. However, the second terminal may be formed on a second side surface (opposite to the first side surface) of the receiving portion 114 or on the cover plate 112. In other embodiments, the second terminal may not be provided separately on the receiving portion 114, and the second electrode tab 124 may instead be electrically connected directly to the case 110.

FIG. 2 illustrates an example of a first electrode 210, a second electrode 220, and a separator 230 according to one or more embodiments of the present disclosure. In the illustrated example of FIG. 2, the first electrode 210, the second electrode 220, and the separator 230 may be sequentially arranged. In FIG. 2, the description will focus on the size of the first electrode 210, the second electrode 220, and the separator 230.

The first electrode 210 may include a first active material layer 214 formed on a first substrate. The first electrode 210 may include a first electrode tab 212 connected to the first substrate. The first electrode tab 212 may extend outwardly from a first side of the first electrode 210. Similarly, the second electrode 220 may include a second active material layer 224 formed on a second substrate. The second electrode 220 may include a second electrode tab 222 connected to the second substrate. The second electrode tab 222 may extend outwardly from a first side of the second electrode 220. Referring to FIG. 2, the extension direction of the first electrode tab 212 of the first electrode 210 and the extension direction of the second electrode tab 222 of the second electrode 220 may be parallel.

In one or more embodiments, a first protective tape 216 may be disposed on the first electrode tab 212. Specifically, the first protective tape 216 may be attached to a region where the first electrode tab 212 contacts the first active material layer 214. The first protective tape 216 may be attached onto at least one surface of the first electrode tab 212. Similarly, a second protective tape 226 may be disposed on the second electrode tab 222. Specifically, the second protective tape 226 may be attached to a region where the second electrode tab 222 contacts the second active material layer 224. The first and second protective tapes 216 and 226 may function to prevent short circuits occurring between the first electrode 210 and the second electrode tab 222 and/or between the second electrode 220 and the first electrode tab 212.

The separator 230 is interposed between the first electrode 210 and the second electrode 220 to prevent a short circuit between the first electrode 210 and the second electrode 220. The separator 230 may include double layers (a first double layer 232_1 and a second double layer 232_2) disposed at one end or the opposite ends of the separator 230. The first double layer 232_1 may be arranged at an upper end of the separator 230. Here, the upper end of the separator 230 may refer to the end portion of the separator 230 located in the extension direction of the first electrode tab 212 or the second electrode tab 222. The second double layer 232_2 may be arranged at a lower end of the separator 230. FIG. 2 illustrates a configuration in which the double layers 232_1 and 232_2 are arranged at opposite ends of the separator 230, but, in other embodiments, only the first double layer 232_1 may be arranged at the upper end of the separator 230.

In one or more embodiments, the double layers 232_1 and 232_2 may be formed by folding a portion of the separator 230. Alternatively, each of the double layers 232_1 and 232_2 may be formed by attaching an insulating tape to the separator 230.

Referring to FIG. 2, a length of the second active material layer 224 may be greater than a length of the first active material layer 214. Here, the lengths of the active material layers or a length of the separator 230 may refer to the length measured in the extension direction of the electrode tabs 212 and 222. Additionally, the length of the separator 230 may be greater than the length of the second active material layer 224. One end of the separator 230 where the first double layer 232_1 is located may protrude beyond the first active material layer 214 and the second active material layer 224 in a longitudinal direction of the separator 230.

In one or more embodiments, the first electrode 210 may serve as the positive electrode, and the second electrode 220 may serve as the negative electrode. That is, the length of the second active material layer 224, which contains a negative active material, may be greater than the length of the first active material layer 214, which contains a positive active material. However, in other embodiments, the first electrode 210 may serve as the negative electrode and the second electrode 220 may serve as the positive electrode.

Further, the first electrode tab 212 may extend in the longitudinal direction of the separator 230 beyond one end of the separator 230 where the first double layer 232_1 is disposed. Similarly, the second electrode tab 222 may extend in the longitudinal direction of the separator 230 beyond one end of the separator 230 where the first double layer 232_1 is disposed. As a result, each of the first electrode tab 212 and the second electrode tab 222 may be exposed from the electrode assembly and connected to the case or to terminals.

In a case where the secondary battery is exposed to heat above a predetermined temperature for a predetermined period of time, the separator 230 may undergo shrinkage. In a case where the shrinkage of the separator 230 occurs, a short circuit between the first electrode 210 and the second electrode 220 may be more likely to occur than before the shrinkage of the separator 230. In the case of a secondary battery according to one or more embodiments of the present disclosure, the rigidity of one end or the opposite ends of the separator 230 may be increased due to the double layers 232_1 and 232_2 arranged at one end or both ends of the separator 230. As a result, the probability of thermal shrinkage of the separator 230 may be reduced. Further, even in a case where the separator 230 does undergo thermal shrinkage, one end or the opposite ends of the separator 230 may exhibit reduced shrinkage, negligible shrinkage, or may remain undamaged. Thus, the separator 230 including the double layers 232_1 and 232_2 may effectively prevent a short circuit between the first electrode 210 and the second electrode 220.

Further, in the event that the secondary battery is subjected to a strong external impact, such as from a drop, components within the electrode assembly, such as the first electrode 210 and the second electrode 220, may be damaged, which may lead to an internal short circuit within the secondary battery. In the secondary battery according to one or more embodiments of the present disclosure, the double layers 232_1 and 232_2 arranged at one end or the opposite ends of the separator 230 may serve as a buffer against external impact, thereby preventing damage to the electrode assembly.

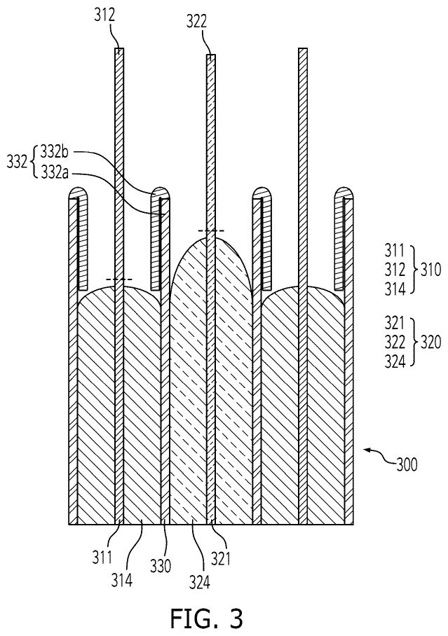

FIG. 3 illustrates a side view of an electrode assembly 300 according to one or more embodiments of the present disclosure. The electrode assembly 300 may include a first electrode 310, a second electrode 320, and a separator 330. The first electrode 310 may include a first substrate 311 and a first active material layer 314 formed on the first substrate 311. The second electrode 320 may include a second substrate 321 and a second active material layer 324 formed on the second substrate 321. The separator 330 may be positioned between the first electrode 310 and the second electrode 320.

The first electrode 310 may include a first electrode tab 312 connected to the first substrate 311, and the second electrode 320 may include a second electrode tab 322 connected to the second substrate 321. The first electrode tab 312 may extend outwardly from a first side of the first electrode 310, and the second electrode tab 322 may extend outwardly from a first side of the second electrode 320. Referring to FIG. 3, an upward direction in which the first electrode tab 312 extends from the first electrode 310 (the extension direction of the first electrode tab 312 from the first electrode 310) may be the same as an upward direction in which the second electrode tab 322 extends from the second electrode 320 (the extension direction of the second electrode tab 322 from the second electrode 320).

In one or more embodiments, the separator 330 may include a double layer 332 disposed at one end of the separator 330. The double layer 332 may be formed by folding a portion of the separator 330. Specifically, the double layer 332 may include a folding portion 332b and an opposing portion 332a facing the folding portion 332b. The folding portion 332b may be a portion of the separator 330 that is folded to form the double layer 332, such that, upon folding, the folding portion 332b may come into contact with the opposing portion 332a.

In one or more embodiments, an adhesive layer may be disposed between the folding portion 332b and the opposing portion 332a. The adhesive layer may bond the folding portion 332b to the opposing portion 332a. The adhesive layer may be applied to one surface of the folding portion 332b, and thereafter, the folding portion 332b may be folded, so that the surface with the adhesive layer faces and adheres to the opposing portion 332a.

In one or more embodiments, the adhesive layer may include a binder. Here, the binder serves to effectively adhere active material particles (for example, negative active material particles and positive active material particles) to one another, as well as to securely attach the active materials (for example, negative active material and positive active material) to a current collector. This binder not only provides adhesive strength necessary to bond the active material particles together but can also be used as an adhesive layer to attach the folding portion 332b to the opposing portion 332a. Representative examples of suitable binders include, polyvinyl alcohol, polyurethane, polytetrafluoroethylene, polyvinylidene fluoride, polyethylene, polypropylene, epoxy resins, (meth)acrylic resins, polyester resins, and nylon, but the binder may vary.

In one or more embodiments, the double layer 332 may be formed by compressing using a roller. Prior to being compressed, the double layer 332 may be a folding portion of the separator 330, and a thickness of the double layer 332 may be approximately twice a thickness of a region of the separator 330 excluding the double layer 332. After compression, the thickness of the double layer 332 may be less than twice the thickness of the region of the separator 330 excluding the double layer 332. This process may strengthen the bonding of the double layer 332 and increase the rigidity of the double layer 332.

For example, the length of the double layer 332 may range from about 0.9 mm to 2.1 mm. Here, the length of the double layer 332 may be measured in a direction in which the electrode tabs 312 and 322 extend. The thickness of the double layer 332 before being compressed may be about 20 μm, while the thickness of the region of the separator 330 excluding the double layer 332 may be about 10 μm. The thickness of the compressed double layer 332 may be less than about 20 μm. However, the thickness and length of the double layer 332 may be determined based on the sizes of the first electrode 310 and the second electrode 320 included in the electrode assembly.

In one or more embodiments, the second active material layer 324 may extend beyond the first active material layer 314 in a direction toward one end (e.g., a top end in the orientation of FIG. 3) of the separator 330 at which the double layer 332 is disposed. In this case, the double layer 332 may be formed by folding a portion of the separator 330 toward the first active material layer 314. Specifically, the double layer 332 may be formed by the folding portion 332b being folded toward the first active material layer 314. This configuration allows for a relatively increased length of the double layer 332, thereby enhancing the rigidity of one end of the separator 330.

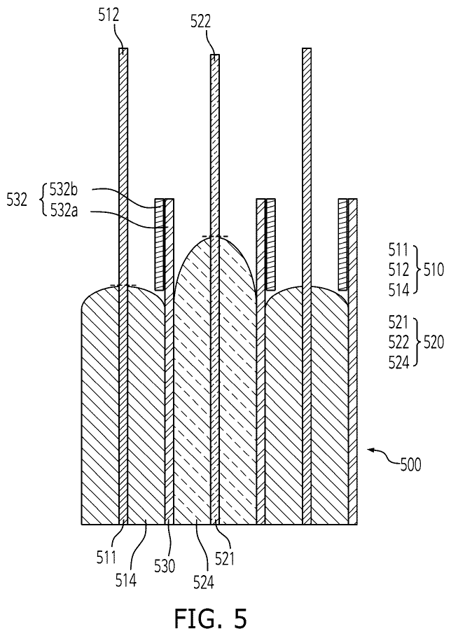

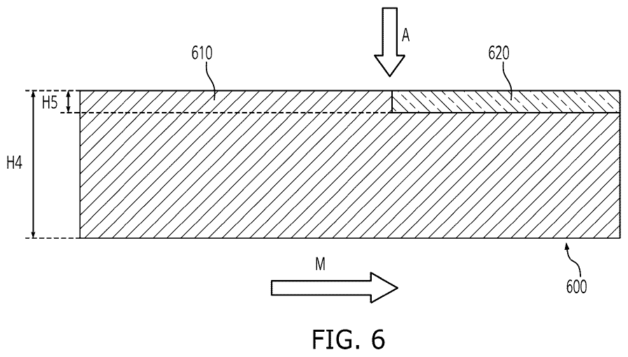

In one or more embodiments, an insulating tape may be attached to a portion of the perimeter of the double layer 332. Here, the insulating tape may be the same as an insulating tape, which will be described with reference to FIGS. 5 and 6. For example, the insulating tape may be attached to specific portions of the side surfaces of the folding portion 332b and the opposing portion 332a. In other embodiments, the insulating tape may be attached to wrap around the perimeter of the double layer 332. This configuration enhances the bonding between the folding portion 332b and the opposing portion 322a, thereby increasing the rigidity of the double layer 332.

In the illustrated example of FIG. 3, a first protective tape may be placed on the first electrode tab 312 and a second protective tape may be placed on the second electrode tab 322. However, for example, as described with respect to FIG. 2, the first protective tape may be attached to the first electrode tab 312 and the second protective tape may be attached to the second electrode tab 322.

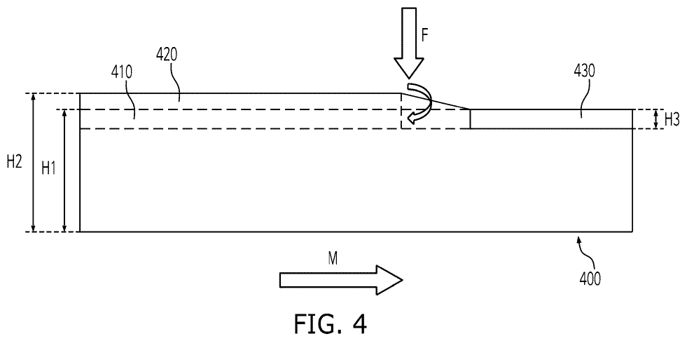

FIG. 4 illustrates a process of folding a separator 400 according to one or more embodiments of the present disclosure. The separator 400 may move along a transport direction M. For example, the separator 400 may be transported through a roll-to-roll process.

In one or more embodiments, the separator 400 may have a portion folded at a folding point F during the transport process. For example, the separator 400 may include an opposing portion 410 and a folding portion 420. At the folding point F, the folding portion 420 of the separator 400 may be folded toward the opposing portion 410. Consequently, the opposing portions 410 and the folding portion 420 may come into contact to form a double layer 430.

In one or more embodiments, an adhesive layer may be positioned on one surface of the folding portion 420 prior to the folding point F. The surface of the folding portion 420 on which the adhesive layer is positioned may be folded so that the folding portion 420 faces the opposing portion 410. The folding portion 420 and the opposing portion 410 may be bonded together by the adhesive force of the adhesive layer, thereby forming the double layer 430.

In one or more embodiments, after the folding portion 420 is folded at the folding point F, the double layer 430 may be compressed by a roller. Specifically, at the folding point F, the folding portion 420 may be folded toward the opposing portion 410. Thereafter, both surfaces (the opposite surfaces) of the double layer 430 may be compressed by the roller or the like. The thickness of the compressed double layer 430 may be less than twice the thickness of the region of the separator 400 excluding the double layer. As a result, the bonding of the double layer 430 may be strengthened, and the rigidity of the double layer 430 may be enhanced.

Referring to FIG. 4, a length H1 of the separator excluding the folding portion may be about 71.5 mm. An overall length H2 of the separator before folding may be about 73 mm. Thus, a length of the folding portion 420 may be about 1.5 mm. A length H3 of the double layer may be about 1.5 mm. However, the length of the separator 400 may be determined based on the sizes of the first electrode and the second electrode included in the electrode assembly.

Subsequently, the separator 400 with the double layer 430 formed thereon may be cut to a predetermined width for use. For example, the cut separator 400 may be laminated with the first electrode and the second electrode to form the electrode assembly. Alternatively, the cut separator 400 may be wound together with the first electrode and the second electrode to form the electrode assembly.

As described above, the double layer 430 may be formed by folding the separator 400 during transport. The process of folding the separator 400 may be simple, which may facilitate inserting the process of folding the separator 400 into an existing secondary battery manufacturing process. Additionally, by increasing the rigidity of the separator 400 through this simple process, it becomes possible to manufacture a secondary battery with improved safety and reliability.

FIG. 5 illustrates a side view of an electrode assembly 500 according to another embodiment of the present disclosure. The electrode assembly 500 may include a first electrode 510, a second electrode 520, and a separator 530. The first electrode 510 may include a first substrate 511 and a first active material layer 514 disposed on the first substrate 511. The second electrode 520 may include a second substrate 521 and a second active material layer 524 disposed on the second substrate 521. The separator 530 may be positioned between the first electrode 510 and the second electrode 520.

The first electrode 510 may include a first electrode tab 512 connected to the first substrate 511, and the second electrode 520 may include a second electrode tab 522 connected to the second substrate 521. The first electrode tab 512 may extend outwardly from a first side of the first substrate 511, and the second electrode tab 522 may extend outwardly from a first side of the second substrate 521. Referring to FIG. 5, an upward direction in which the first electrode tab 512 extends from the first electrode 510 may be the same as an upward direction in which the second electrode tab 522 extends from the second electrode 520.

In one or more embodiments, the separator 530 may include a double layer 532 disposed at one end of the separator 530. The double layer 532 may include a contact portion 532a, which forms a portion of the separator 530, and an insulating tape 532b attached onto the contact portion 532a. Specifically, one surface of the insulating tape 532b has adhesive properties, and this surface of the insulating tape 532b may be placed on the contact portion 532a.

In one or more embodiments, the insulating tape 532b may include an insulating material. Here, the insulating material may include a material having the characteristic of preventing current flow by providing electrical insulation. For instance, the insulating tape 532b may contain the same material as the separator 530. For example, the insulating tape 532b may include at least one of polyimides (PI) or polyethylene terephthalate (PET).

In one or more embodiments, the double layer 532 may be formed by compression using a roller. Prior to being compressed, the double layer 532 may be formed by attaching the insulating tape 532b onto the contact portion 532a of the separator 530, and a thickness of the double layer 532 may be approximately twice a thickness of the region of the separator 530 excluding the double layer. After compression, the thickness of the double layer 532 may be less than twice the thickness of the region of the separator 530 excluding the double layer. This process may strengthen the bonding of the double layer 532 and increase the rigidity of the double layer 532.

In one or more embodiments, the thickness of the insulating tape 532b may be greater than the thickness of the separator 530. For example, the thickness of the separator 530 may be about 10 μm. In this case, the thickness of the insulating tape 532b may be greater than about 10 μm. The thickness of the double layer 532 may be greater than about 20 μm.

For example, a length of the double layer 532 may range from about 0.9 mm to 2.1 mm. Here, the length of the double layer 532 may be measured in a direction in which the electrode tabs 512 and 522 extend. However, the thickness and length of the double layer 532 may be determined based on the sizes of the first electrode 510 and the second electrode 520 included in the electrode assembly.

In one or more embodiments, the second active material layer 524 may extend beyond the first active material layer 514 in a direction toward one end of the separator 530 at which the double layer 532 is disposed. A first surface of the separator 530 may face the first active material layer 514, and a second surface of the separator 530, opposite to the first surface, may face the second active material layer 524. The insulating tape 532b may be attached onto the first surface of the separator 530. Specifically, the insulating tape 532b may be attached onto the contact portion 532a on the first surface of the separator 530. This configuration allows for a relatively increased length of the double layer 532, thereby enhancing the rigidity of one end of the separator 530.

In FIG. 5, a first protective tape may be placed on the first electrode tab 512 and a second protective tape may be placed on the second electrode tab 522. For example, as described in FIG. 2, the first protective tape may be attached to the first electrode tab 512, and the second protective tape may be attached to the second electrode tab 522.

FIG. 6 illustrates a process of attaching an insulating tape 620 to a separator 600 according to one or more embodiments of the present disclosure. The separator 600 may move along the transport direction M. For example, the separator 600 may be transported through a roll-to-roll process.

In one or more embodiments, the separator 600 may form a double layer by having the insulating tape 620 attached at a tape attachment point A during transport. Specifically, the insulating tape 620 may be attached onto a contact portion 610 that is a portion of the separator 600. One surface of the insulating tape 620 has adhesive properties, and this surface of the insulating tape 620 may be placed on the contact portion 610.

In one or more embodiments, after the insulating tape 620 is attached onto the contact portion 610 at the tape attachment point A, the double layer may be compressed by a roller. Specifically, the insulating tape 620 may be attached onto the contact portion 610 at the tape attachment point A. Thereafter, both surface (the opposite surfaces) of the double layer may be compressed by the roller or the like. The thickness of the compressed double layer may be less than twice the thickness of the region of the separator 600 excluding the double layer. As a result, the bonding of the double layer may be strengthened, and the rigidity of the double layer may be enhanced.

Referring to FIG. 6, an overall length H4 of the separator may be approximately 70 mm. A length H5 of the contact portion is about 1.5 mm, and a length of the insulating tape 620 may also be approximately 1.5 mm. However, the length of the separator 600 may be determined based on the sizes of the first electrode and the second electrode included in the electrode assembly.

Subsequently, the separator 600 with the double layer formed thereon may be cut to a predetermined width for use. For example, the cut separator 600 may be laminated with the first electrode and the second electrode to form an electrode assembly. In other embodiments, the cut separator 600 may be wound together with the first electrode and the second electrode to form the electrode assembly.

As described above, the double layer may be formed by attaching the insulating tape 620 to the separator 600 during transport. The process of attaching the insulating tape 620 to the separator 600 may be simple, which may facilitate inserting the process of attaching the insulating tape 620 into an existing secondary battery manufacturing process. Furthermore, by increasing the rigidity of the separator 400 through this simple process, it becomes possible to manufacture a secondary battery with improved safety and reliability.

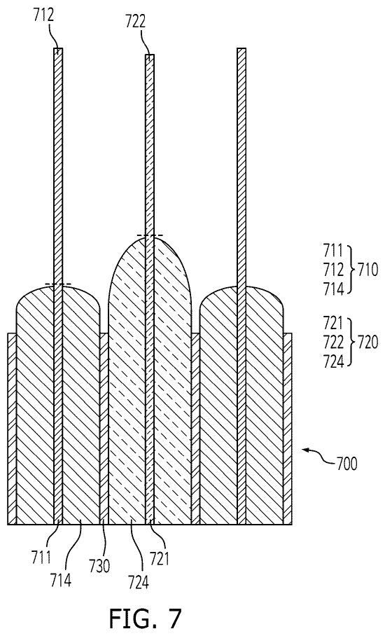

FIG. 7 illustrates a side view of a thermally shrunk electrode assembly 700 according to a comparative example of the present disclosure. The electrode assembly 700 shown in FIG. 7 may be identical to the electrode assembly 500 shown in FIG. 5, except that the insulating tape 532b is not attached in FIG. 7. While components within the electrode assembly 700, other than the separator 730, may also undergo thermal shrinkage, the degree of thermal shrinkage in these components is expected to be relatively less significant than that of separator 730. In FIG. 7, the description will focus on illustrating the thermally shrunk appearance of the separator 730.

For example, the electrode assembly 700 may include a first electrode 710, a second electrode 720, and a separator 730. The first electrode 710 may include a first substrate 711 and a first active material layer 714 formed on the first substrate 711. The second electrode 720 may include a second substrate 721 and a second active material layer 724 formed on the second substrate 721. The separator 730 may be positioned between the first electrode 710 and the second electrode 720.

Further, the first electrode 710 may include a first electrode tab 712 connected to the first substrate 711, and the second electrode 720 may include a second electrode tab 722 connected to the second substrate 721. The first electrode tab 712 may extend outwardly from a first side of the first substrate 711, and the second electrode tab 722 may extend outwardly from a first side of the second substrate 721. Referring to FIG. 7, an upward direction in which the first electrode tab 712 extends may be the same as an upward direction in which the second electrode tab 722 extends.

An upper end of the separator 730 may form a single layer. In a case where the electrode assembly 700 receives heat from an external source, the separator 730 may undergo thermal shrinkage. In the illustrated example of FIG. 7, the thermally shrunk separator 730 may have its upper end inserted between the first active material layer 714 and the second active material layer 724. Prior to the thermal shrinkage, the separator 730 may separate the first active material layer 714 and the second active material layer 724. After the thermal shrinkage, the first active material layer 714 and the second active material layer 724 may be exposed at a region of the upper end of the separator 730, which can result in a short circuit between the first electrode 710 and the second electrode 720.

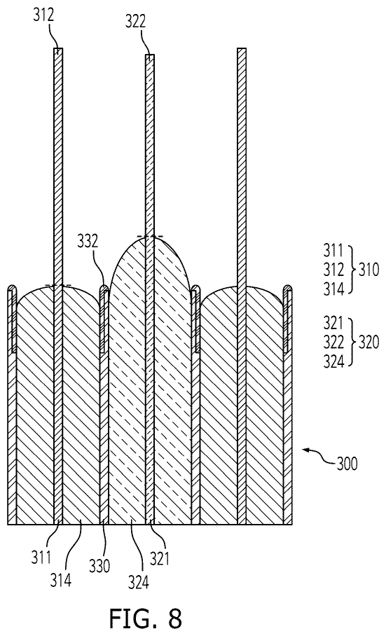

FIG. 8 illustrates a side view of a thermally shrunk electrode assembly 800 according to one or more embodiments of the present disclosure. FIG. 8 illustrates a state in which heat has been applied to the electrode assembly 300 of FIG. 3, resulting in the thermal shrinkage of the separator 330. While components within the electrode assembly 300, other than the separator 330, may also undergo thermal shrinkage, the degree of thermal shrinkage in these components is expected to be relatively less significant than that of separator 330. In FIG. 8, the description will focus on illustrating the thermally shrunk appearance of the separator 330.

In one or more embodiments, the separator 330 may undergo thermal shrinkage, such that a length of the separator 330 is shorter than its original length prior to the thermal shrinkage. One end of separator 330 at which the double layer 332 is disposed may shrink in a direction toward the interface between the first active material layer 314 and the second active material layer 324. The double layer 332 may have a greater thickness and a greater rigidity compared to other regions of separator 330 except for the double layer 332, which may result in a lower degree of thermal shrinkage compared to the case in which the single layer is formed. Additionally, due to its relatively greater thickness, the double layer 332 may be difficult to be inserted between the first active material layer 314 and the second active material layer 324. Consequently, the first active material layer 314 and the second active material layer 324 may remain separated by the separator 330. In other words, even when the separator 330 undergoes thermal shrinkage, the separator 330 having the double layer 332 may still prevent a short circuit between the first electrode 310 and the second electrode 320.

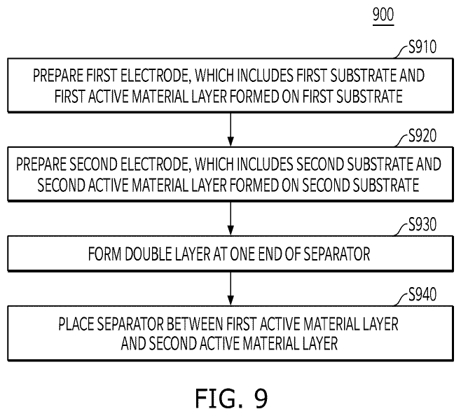

FIG. 9 illustrates a flowchart 900 of an example of a method for manufacturing a secondary battery according to one or more embodiments of the present disclosure. A secondary battery manufacturing apparatus may be an apparatus for manufacturing a secondary battery according to one or more embodiments of the present disclosure.

In one or more embodiments, the method for manufacturing a secondary battery may begin by preparing a first electrode, which includes a first substrate and a first active material layer formed on the first substrate, using the secondary battery manufacturing apparatus (step S910).

In one or more embodiments, the secondary battery manufacturing apparatus may prepare a second electrode, which includes a second substrate and a second active material layer formed on the second substrate (step S920).

In one or more embodiments, the secondary battery manufacturing apparatus may form a double layer at one end of the separator (step S930). For example, the secondary battery manufacturing apparatus may form the double layer by folding a portion of the separator. In one or more other embodiments, the secondary battery manufacturing apparatus may form a double layer that includes a contact portion, which is a portion of the separator, and an insulating tape attached onto the contact portion.

In one or more embodiments, one end of the separator may protrude beyond the first active material layer and the second active material layer in the longitudinal direction of the separator. Additionally, the second active material layer may extend beyond the extent of the first active material layer in a direction toward one end of the separator, and the double layer may be formed by folding a portion of the separator toward the first active material layer. Here, the first active material layer may include a positive electrode active material, and the first electrode may be a positive electrode.

In one or more embodiments, the double layer may include a folding portion that is folded to form the double layer, an opposing portion facing the folding portion, and an adhesive layer positioned between the folding portion and the opposing portion. Here, the adhesive layer may include a binder.

In one or more embodiments, the double layer may be compressed by a roller, and the thickness of the compressed double layer may be no more than twice the thickness of a region of the separator excluding the double layer.

In one or more embodiments, the first electrode may include a first electrode tab connected to the first substrate, and the second electrode may include a second electrode tab connected to the second substrate. Each of the first and second electrode tabs extending beyond one end of the separator in the longitudinal direction of the separator.

In one or more embodiments, the double layer may include a contact portion, which is a portion of the separator, and an insulating tape attached onto the contact portion. Specifically, the insulating tape may include the same material of the separator. For example, the insulating tape may include at least one of polyimides (PI) or polyethylene terephthalate (PET). Additionally, the thickness of the insulating tape may be greater than the thickness of the separator.

In one or more embodiments, a portion of the second active material layer may extend beyond the first active material layer in the longitudinal direction of the separator. The separator may have a first surface and a second surface opposite to the first surface. The first surface faces the first active material layer and the second surface faces the second active material layer. The insulating tape may be disposed on the first surface.

In one or more embodiments, the secondary battery manufacturing apparatus may place the separator between the first active material layer and the second active material layer (step S940).

Specifically, the secondary battery manufacturing apparatus may provide an electrode assembly for a secondary battery that includes a first electrode including a first substrate and a first active material layer formed on the first substrate, a second electrode including a second substrate and a second active material layer formed on the second substrate, and a separator disposed between the first active material layer and the second active material layer. Here, the separator may include a double layer formed at one end of the separator.

The flowchart and the aforementioned descriptions of FIG. 9 are merely examples of the present disclosure. For instance, one or more steps in the flowchart and the aforementioned descriptions may be added, modified, and/or deleted, the sequence of one or more steps may be changed, and one or more steps may be performed simultaneously.

In cases where the secondary battery is constantly utilized or exposed to extreme conditions, it is easy for the positive electrode and the negative electrode to come into electrical contact. If two materials with different electrode polarities come into electrical contact within the secondary battery, an internal short may arise. For example, when the secondary battery is exposed to heat, the positions or arrangements of the internal components of the secondary battery may change due to shrinkage (contraction) and expansion of these components, which may lead to a short circuit within the secondary battery. Such an internal short circuit may rapidly increase a temperature of the secondary battery, and in severe cases, may result in a fire.

Furthermore, during use, the secondary battery may be subjected to external impacts, such as drops. In such cases, the internal components of the secondary battery (e.g., the electrode assembly) may be displaced or impacted, causing internal damage to the secondary battery. Such damage may cause the secondary battery to become inoperative, resulting in no power storage or output, or leading to a fire as a result of a short circuit.

According to various embodiments of the present disclosure, the double layer arranged at one end or both ends of the separator can increase the rigidity of one end or both ends of the separator. With such configuration, even in a case where the separator undergoes thermal shrinkage, one end or both ends of the separator can exhibit reduced shrinkage, negligible shrinkage, or can remain undamaged. Thus, the separator including the double layer can effectively prevent a short circuit between the first electrode and the second electrode.

According to various embodiments of the present disclosure, the double layer arranged at one end or both ends of the separator can serve as a buffer against external impact, thereby preventing damage to the electrode assembly.

According to various embodiments of the present disclosure, the double layer can be formed by folding the separator during transport. The process of folding the separator is simple, which can facilitate inserting the process of folding the separator into an existing secondary battery manufacturing process. Additionally, by increasing the rigidity of the separator through this simple process, it becomes possible to manufacture a secondary battery with improved safety and reliability.

According to various embodiments of the present disclosure, the double layer can be formed by attaching the insulating tape to the separator during transport. The process of attaching the insulating tape to the separator is simple, which can facilitate inserting the process of attaching the insulating tape into an existing secondary battery manufacturing process. Furthermore, by increasing the rigidity of the separator through this simple process, it becomes possible to manufacture a secondary battery with improved safety and reliability.

According to various embodiments of the present disclosure, the double layer can have a greater thickness and a greater rigidity compared to other regions of separator except for the double layer, which results in a lower degree of thermal shrinkage compared to the case in which the single layer is formed. Additionally, due to its relatively greater thickness, it becomes difficult for the double layer to be inserted between the first active material layer and the second active material layer. Consequently, the first active material layer and the second active material layer can remain separated by the separator. In other words, even when the separator undergoes thermal shrinkage, the separator having the double layer can still prevent a short circuit between the first electrode and the second electrode.

Although the present disclosure has been described above with respect to embodiments thereof, the present disclosure is not limited thereto. Various modifications and variations can be made thereto by those skilled in the art within the spirit of the present disclosure and the equivalent scope of the appended claims.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

Explanation of reference symbols
100: secondary battery
110: case
112: cover plate
114: receiving portion
114a: opening
114b: first side surface
120: electrode assembly
122: first electrode tab
124: second electrode tab

What is claimed is:

1. A secondary battery, comprising:
a first electrode comprising a first substrate and a first active material layer on the first substrate;
a second electrode comprising a second substrate and a second active material layer on the second substrate; and
a separator between the first active material layer and the second active material layer,
wherein the separator comprises a double layer at a first end of the separator.

2. The secondary battery as claimed in claim 1, wherein the double layer is a folded portion of the separator.

3. The secondary battery as claimed in claim 1, wherein the first end of the separator protrudes beyond the first active material layer and the second active material layer in a longitudinal direction of the separator.

4. The secondary battery as claimed in claim 1, wherein:
the second active material layer extends beyond the first active material layer in a direction toward the first end of the separator, and
the double layer is a portion of the separator folded toward the first active material layer.

5. The secondary battery as claimed in claim 4, wherein:
the first active material layer comprises a positive electrode active material, and
the first electrode is a positive electrode.

6. The secondary battery as claimed in claim 1, wherein the double layer comprises:
a folded portion of the separator,
an opposing portion facing the folded portion, and
an adhesive layer between the folded portion and the opposing portion.

7. The secondary battery as claimed in claim 6, wherein the adhesive layer comprises a binder.

8. The secondary battery as claimed in claim 1, wherein:
the double layer is compressed, resulting in a compressed double layer, and
a thickness of the compressed double layer is equal to or less than twice a thickness of a region of the separator excluding the double layer.

9. The secondary battery as claimed in claim 1, wherein:
the first electrode comprises a first electrode tab connected to the first substrate,
the second electrode comprises a second electrode tab connected to the second substrate, and
each of the first electrode tab and the second electrode tab extends beyond the first end of the separator in a longitudinal direction of the separator.

10. The secondary battery as claimed in claim 1, wherein the double layer comprises:
a contact portion of the separator, and
an insulating tape attached to the contact portion.

11. The secondary battery as claimed in claim 10, wherein the insulating tape comprises a same material as the separator.

12. The secondary battery as claimed in claim 10, wherein the insulating tape comprises at least one of polyimides and polyethylene terephthalate.

13. The secondary battery as claimed in claim 10, wherein a thickness of the insulating tape is greater than a thickness of the separator.

14. The secondary battery as claimed in claim 10, wherein:
a portion of the second active material layer extends beyond the first active material layer in a longitudinal direction of the separator,
the separator has a first surface and a second surface opposite to the first surface,
the first surface of the separator faces the first active material layer,
the second surface of the separator faces the second active material layer, and
the insulating tape is on the first surface.

15. An electrode assembly for a secondary battery, the electrode assembly comprising:
a first electrode comprising a first substrate and a first active material layer on the first substrate;
a second electrode comprising a second substrate and a second active material layer on the second substrate; and
a separator between the first active material layer and the second active material layer,
wherein the separator comprises a double layer at a first end of the separator.

16. The electrode assembly as claimed in claim 15, wherein the double layer is a folded portion of the separator.

17. The electrode assembly as claimed in claim 15, wherein the double layer comprises:
a contact portion of the separator, and
an insulating tape attached to the contact portion.

18. A method for manufacturing a secondary battery, the method comprising:
preparing a first electrode comprising a first substrate and forming a first active material layer on the first substrate;
preparing a second electrode comprising a second substrate and forming a second active material layer on the second substrate; and
disposing a separator between the first active material layer and the second active material layer,
wherein the separator comprises a double layer formed at a first end of the separator.

19. The method as claimed in claim 18, further comprising forming the double layer by folding a portion of the separator.

20. The method as claimed in claim 18, further comprising:
forming the double layer comprising a contact portion of the separator, and
attaching an insulating tape to the contact portion.
